(19) United States
(12) Patent Application Publication
(10) Pub. No.: US 2005/0259526 A1
(43) Pub. Date: Nov. 24, 2005

(54) High sensitivity actuator for an optical pick-up head

(76) Inventor: Ling-Chen Chang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/711,260

(22) Filed: Sep. 6, 2004

(30) Foreign Application Priority Data
May 18, 2004 (TW) 093113994

(51) Int. Cl. G11B 7/00

(52) U.S. Cl. 369/44.14; 369/44.15; 369/44.22

(57) ABSTRACT

An actuator for an optical pick-up head performs high sensitivity of tracking and focusing. The sensitivity of the optical pick-up head is increased by changing the magnetic arrangement of a first permanent magnet and a second permanent magnet of an actuator, such that opposing direction of magnetic fields are provided to inner parts and outer parts of tracking coils of the actuator, thereby increasing the consistency of the forces induced by the magnets and tracking coils.

### BACKGROUND OF INVENTION

1. Field of the Invention

The present invention is related to an optical pick-up head, and more particularly, an optical pick-up head with an actuator having permanent magnets with different magnetic areas for increasing sensitivity and power efficiency of movement of an optical lens set of the optical pick-up head.

2. Description of the Prior Art

In a modern information society, compact, light, high-density, and low-cost optical discs have become one of the most popular non-volatile storage media. In order to speed up access time to data densely recorded on an optical disc, it is a critical issue to improve operating efficiency of an optical disc storage device such as optical disc drives or CD players.

Please refer to FIG. 1, which illustrates a schematic diagram of a prior art optical pick-up head 10. The optical pick-up head 10 includes an optical lens set 12, an actuator 14, a laser diode 16, a photo detector 18, suspension lines 20, and a processing circuit 22. The processing circuit 22 controls the laser diode 16 for emitting a laser beam onto a designated position of an optical disc through the optical lens set 12, and determines whether the optical lens set 12 focuses on, or tracks to, the designated position accurately according to a reflected laser beam reaching the photo detector 18. If the processing circuit 22 determines that the optical lens set 12 is not focused on or tracked to the position accurately according to the reflected laser beam, the processing circuit 22 drives the actuator 14 for fine-tuning of the optical lens set 12 with a closed-loop controlling circuit. The optical lens set 12 is fixed to the actuator 14 with the suspension lines 20, and is free to move vertically and horizontally. As to detailed configuration of the actuator 14, please refer to FIG. 2, which illustrates a schematic diagram of the actuator 14. The actuator 14 includes a focusing coil 24, a first tracking coil set 26, a second tracking coil set 28, a first permanent magnet 30, and a second permanent magnet 32. The direction of the magnetic field generated by the first permanent magnet 30 is different from that generated by the second permanent magnet 32 as illustrated by arrows 34 and 35 in FIG. 2 that indicate magnetic lines of force. That is, the first permanent magnet 30 and the second permanent magnet 32 are disposed on two sides of the optical pick-up head 10 along a tracking line 36 with repelling magnetic poles at a distance D from the optical lens set 12. The focusing coil 24 is mounted on the optical lens set 12 horizontally. Both the first tracking coil set 26 and the second tracking coil set 28 include two coils mounted on one side of the optical lens set 12, parallel to the tracking line 36.

Please refer to FIG. 3, which illustrates a vector diagram of electromagnetic induction force F with a magnetic force B and a current I. A directive unit vector L of the current I, the magnetic force B, and the force F are perpendicular to one another, and a representative formula is F=IL×B, where F, L, and B are vectors, while “×” means cross product, so that the force F is directly proportional to the current I or the magnetic force B. According to the formula, the focusing coil 24 can be used to adjust the vertical position of the optical lens 12 by tuning the focusing coil current. Similarly, the first tracking coil set 26 and the second tracking coil set 28 can also be used to adjust the horizontal position of the optical lens set 12 approximately parallel to the tracking line 36 as shown in FIG. 2 by tuning the respective coil currents.

Please refer to FIG. 4A and FIG. 4B, which illustrate schematic diagrams of the focusing coil 24 when generating an electromagnetic induction force Fp with the first permanent magnet 30 and the second permanent magnet 32. FIG. 4A is a diagram of the optical pick-up head 10 in FIG. 1 representing a portion of the focusing coil 24 that is viewed from the first permanent magnet 30 in a direction corresponding to the magnetic force arrow 34 of FIG. 2. An area 38 is the coverage area of the first permanent magnet 30, and the “ ” symbols illustrate the direction of magnetic lines of force as toward the optical lens set 12. When the focusing coil 24 includes a current flowing as indicated by arrow 40, the force Fp is provided by electromagnetic induction between the first permanent magnet 30 and the focusing coil 24 in the area 38 as shown in FIG. 4B. If the first permanent magnet 30 and the second permanent magnet 32 are disposed to face each other with their N poles (that is, magnetic lines of both the first permanent magnet 30 and the second permanent magnet 32 go toward the optical lens set 12), and the current direction of the focusing coil 24 is as indicated by the arrow 40, both sides of the focusing coil 24 generate equal amounts of force Fp with the first permanent magnet 30 and the second permanent magnet 32. The force Fp increasing with the current present in, or the number of windings of the focusing coil 24, or with an increase in the magnetic forces of the first and second permanent magnets 30 & 32. Therefore, when the optical lens set 12 is far from focus in the sense of being too far distant from the object media, the processing circuit 22 can drive the focusing coil 24 of the actuator 14 upward for fine-tuning the vertical position of the optical lens set 12 with the upward force Fp until the optical lens set 12 focuses on the optical disc accurately. Similarly, when the optical lens set 12 is too close to the object media to achieve focus, the processing circuit 22 can drive the focusing coil 24 of the actuator 14 downward for fine-tuning the vertical position of the optical lens set 12 with downward force −Fp provided by a current in a direction reverse to arrow 40.

As to the tracking process of the first tracking coil set 26 and the second tracking coil set 28 of the actuator 14, please refer to FIG. 5A, which illustrates a schematic diagram of the optical pick-up head 10 in FIG. 1 as viewed from the first permanent magnet 30 in a direction corresponding to the magnetic force arrow 34 of FIG. 2, with only the first tracking coil set 26 shown in full, and where an area 42 is the coverage area of the first permanent magnet 30, and the “ ” symbols illustrate the direction of magnetic lines of force as toward the optical lens set 12. When the first tracking coil set 26 is driven by a current flowing as indicated by arrow 44, a leftward force Fh is provided by electromagnetic induction between the first permanent magnet 30 and the tracking coil set 26 within the area 42 as shown in FIG. 5B. Similarly, the second tracking coil set 28 and the second permanent magnet 32 can be arranged to generate a leftward force Fh as well. Therefore, combining these two leftward forces Fh provided by the first tracking coil set 26 and the second tracking coil set 28 with the first permanent magnet 30 and the second permanent magnet 32, the optical lens set 12 can be moved leftward. The electromagnetic induction force Fh that moves the optical lens set 12 increases as the amount of current present in, or the number of windings of, the first and second tracking coil sets 26 & 28, or with an increase in magnetic force of the first and second permanent magnets 28 & 32. Conversely, the processing circuit 22 can also drive the first tracking coil set 26 and the second tracking coil set 28 of the actuator 14 rightward, fine-tuning the optical lens set 12 with rightward force −Fh provided by a current in a direction reverse to arrow 44. Thus, the electromagnetic induction force ±Fh can be used to drive the optical lens set 12 in a lateral sense, i.e. a tangential direction to an optical disc (approximately parallel to the tracking line 36 as shown in FIG. 2).

However, continuing with discussion of FIG. 5A, the magnitude and direction of the current in the portion of the first tracking coil set 26 outside the area 42 is respectively equivalent and at opposite direction to that in the portion of the first tracking coil set 26 inside the area 42. Therefore, as shown in FIG. 5C, the portion of the first tracking coil set 26 outside the area 42 generates an electromagnetic induction force Fo in opposition to the force Fh. Fo usually has less strength than the force Fh since it is subject to a lower magnetic field intensity as being outside the coverage area of the first permanent magnet 30 (area 42). Like the force Fh, the force Fo is similarly effected by increases in the current present in, or the number of windings of, the first tracking coil 26, or by increases in the magnetic force of the first permanent magnet 30. Because it opposes the force Fh, the force Fo decreases the efficiency of the force Fh to move the optical lens set 12. Moreover, in order to allow the optical pick-up head 10 to move the optical lens set 12 more rapidly, the current or number of windings of the first tracking coil set 26 and the second tracking coil set 28, must be increased to generate a greater force Fh. However, increasing current or number of windings in the coil sets, increases not only the force Fh, but also the opposing force Fo. As a result, the electromagnetic induction force provided by the first tracking coil set 26 and the first permanent magnet 30 for moving the optical lens set 12, can be expressed by Fr=Fh−Fo. That is to have a force Fr to move the optical lens set 12, certain amounts of currents provided to the coils are not used to generate a force to push the optical lens set 12 but to cancel the effect of the force Fo.

Please refer to FIG. 6, which illustrates a schematic diagram of another type of prior art actuator 48 of an optical pick-up head. The actuator 48 includes a first permanent magnet 50, a second permanent magnet 52, a focusing coil 54, a first tracking coil set 66, and a second tracking coil set 68. The first permanent magnet 50 and the second permanent magnet 52 are disposed to face each other with different poles, which means directions of the magnetic field of the first permanent magnet 50 and the second permanent magnet 52 are in the same sense (as arrows 60 and 61 shown in FIG. 6 for illustrating magnetic lines). The focusing coil 54 includes a first focusing coil 56 and a second focusing coil 58, each set in two sides near the first permanent magnet 50 and the second permanent magnet 52. The first focusing coil 56 and the second focusing coil 58 include currents with different directions (as arrows 62, 64 show) for generating electromagnetic induction forces with the first permanent magnet 50 and the second permanent magnet 52 that are in the same sense. Similarly, the first tracking coil set 66 and the second focusing coil 68 are provided with currents having different directions for generating stable electromagnetic induction forces horizontally. However, in this case, as with the previously described arrangement, a force opposite to the tracking line occurs and decreases the tracking efficiency of the actuator 48.

In summary, owing to the configuration of permanent magnets and tracking coils in prior art optical pick-up head arrangements, portions of the tracking coils falling outside the coverage area of the permanent magnet provide a force in opposition to the lateral force required to move the optical lens set along the tracking line, and as long as current exists in the tracking coil, the force exists accordingly. Therefore, the prior art optical pick-up head wastes power on counterbalancing the opposing force, which may limit maximum operating speed of the optical pick-up head. Furthermore, in order to increase movement force, the prior art optical pick-up head increases the number of windings of the tracking coils, which not only increases the weight of the tracking coils, but also causes an increase in the distance between the optical lens set and the permanent magnet to allow for additional bulk, which in turn places the focus coil further from the effective magnetic field of the permanent magnet. In short, the prior art optical pick-up head inevitably wastes resources in order to achieve fast tracking and focusing.

### SUMMARY OF INVENTION

It is therefore a primary objective of the claimed invention to provide a high-sensitivity actuator of an optical pick-up head.

The present invention discloses an optical pick-up head including an optical lens set for focusing laser beams onto an optical disc and an actuator for fine-tuning the optical lens set. The actuator includes a first tracking coil set mounted on a first side of the optical lens set, a second tracking coil set mounted on a second side of the optical lens set, a first permanent magnet having at least two magnetic areas, each having a different polar arrangement from the adjacent magnetic areas on the first side of the optical lens disposed with a distance, and a second permanent magnet having at least two magnetic areas each having a different polar arrangement from the adjacent magnetic areas on the second side of the optical lens disposed with a distance.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a schematic diagram of a prior art optical pick-up head.

FIG. 2 illustrates a schematic diagram of an actuator in FIG. 1.

FIG. 3 illustrates a schematic diagram of electromagnetic induction.

FIG. 4A illustrates a configuration diagram of the focusing coil and the first permanent magnet in FIG. 2.

FIG. 4B illustrates a schematic diagram of electromagnetic induction.

FIG. 5A illustrates a configuration diagram of the first tracking coil and the first permanent magnet in FIG. 2.

FIG. 5B and FIG. 5C illustrate schematic diagrams of electromagnetic induction.

FIG. 6 illustrates a schematic diagram of another type of prior art optical pick-up head with an actuator having permanent magnets with same-direction magnetic areas.

FIG. 7 illustrates a schematic diagram of a present invention optical pick-up head.

FIG. 8 illustrates a configuration diagram of the actuator in FIG. 7.

FIG. 9A illustrates a configuration diagram of the first tracking coil and the first permanent magnet in FIG. 7.

FIG. 9B and FIG. 9C illustrate schematic diagrams of electromagnetic induction.

FIG. 10, FIG. 11, and FIG. 12 illustrate configuration diagrams of actuators of embodiments in accordance with the present invention.

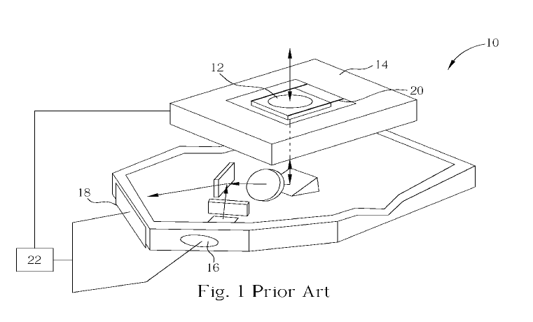

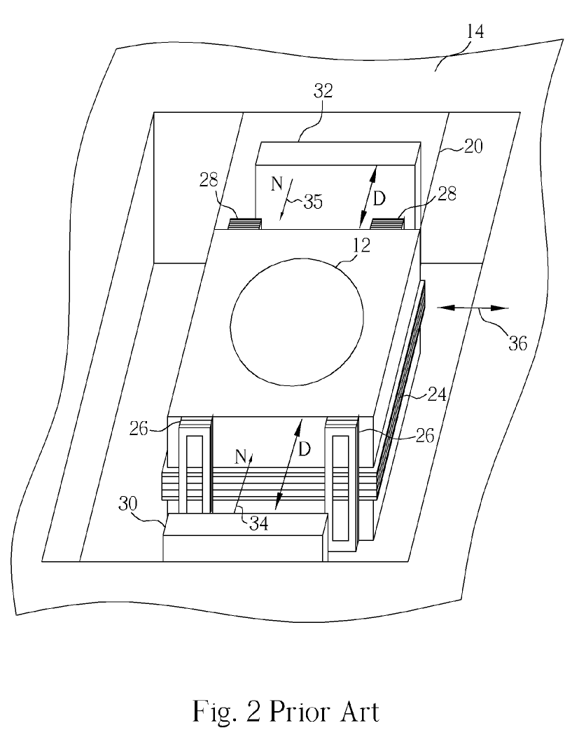

### DETAILED DESCRIPTION

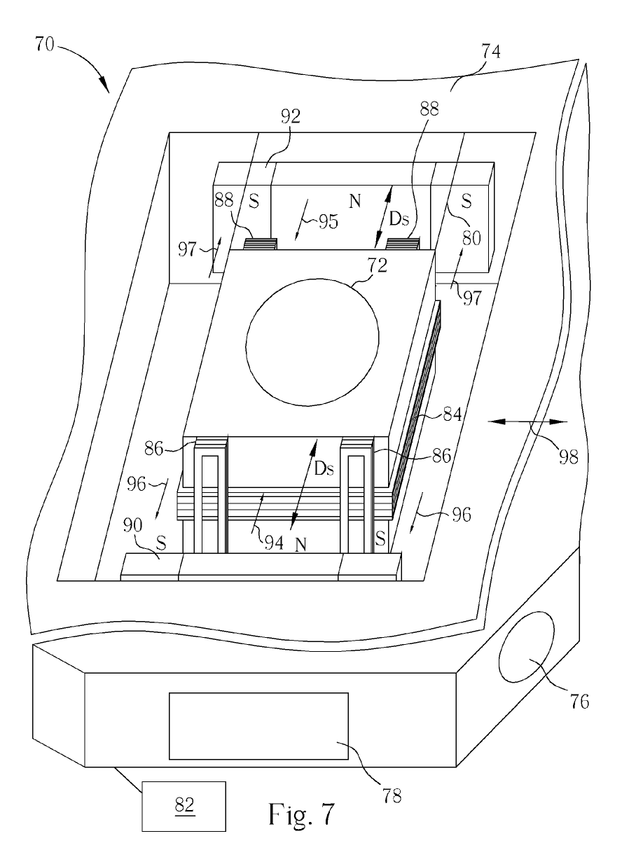

Please refer to FIG. 7, which illustrates a schematic diagram of a present invention optical pick-up head 70. The optical pick-up head 70 includes an optical lens set 72, an actuator 74, a laser diode 76, a photo detector 78, suspension lines 80, and a processing circuit 82. The processing circuit 82 controls the laser diode 76 for emitting a laser beam onto a designated position of an optical disc through the optical lens set 72, and determines whether the optical lens set 12 focuses on or tracks to the designated position accurately according to a reflected laser beam with the photo detector 78. If the processing circuit 82 determines that the optical lens set 72 does not focus on or track to the designated position accurately according to the reflected laser beam, the processing circuit 82 enables the actuator 74 for fine-tuning the optical lens set 72 with a closed-loop controlling circuit. The optical lens set 72 is fixed to the actuator 74 with the suspension lines 80, and is free to move vertically and horizontally. The actuator 74 includes a focusing coil 84, a first tracking coil set 86, a second tracking coil set 88, a first permanent magnet 90, and a second permanent magnet 92, where both the first permanent magnet 90 and the second permanent magnet 92 include at least two magnetic areas. For example, the first permanent magnet 90 includes three magnetic areas with an S-N-S polar arrangement facing the optical lens set 72. That is, the center portion of the first permanent magnet 90 faces the optical lens set 72 with its N pole, while the two portions flanking the center portion face the optical lens set 72 with their S poles (and the magnetic lines of forces are as arrows 94, 95, 96, 97 shown in FIG. 7). Accordingly, the second permanent magnet 92 includes three magnetic areas with S-N-S polar arrangement facing the optical lens set 72, so that the first permanent magnet 90 and the second permanent magnet 92 are disposed with repelling magnetic fields. The first permanent magnet 90 and the second permanent magnet 92 are disposed on two sides of the optical pick-up head 70 along a tracking line 98 with repelling magnetic poles at a distance Ds from the optical lens set 12. The focusing coil 84 is mounted on the optical lens set 72 horizontally. Both the first tracking coil set 86 and the second tracking coil set 88 include two coils mounted on one side of the optical lens set 12 parallel to the tracking line 98.

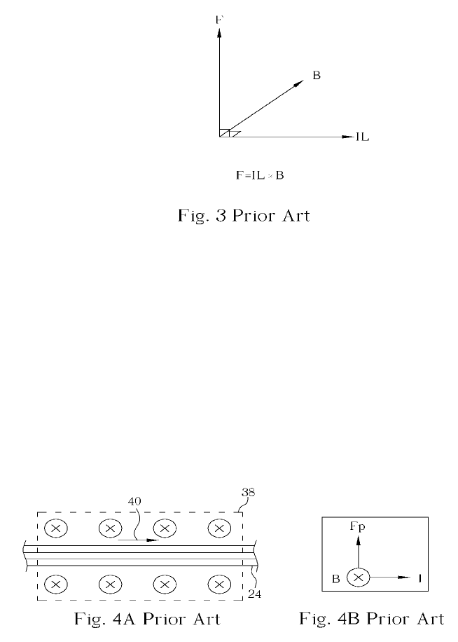

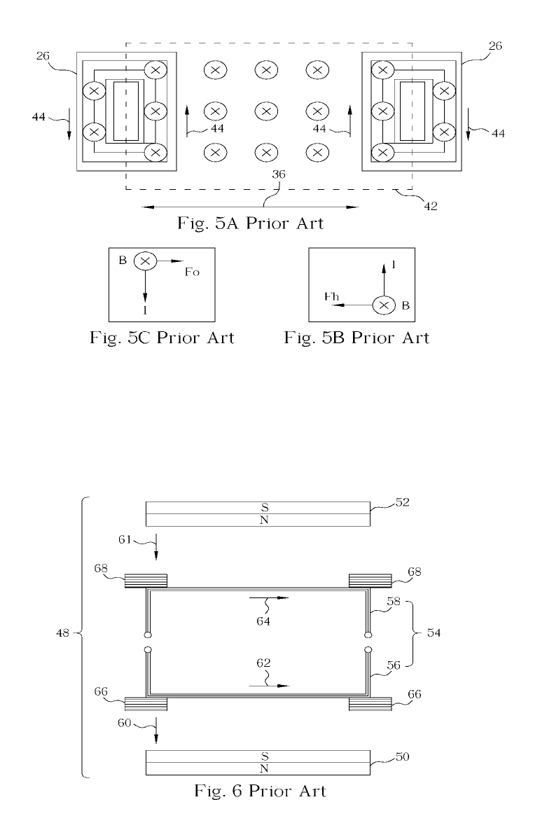

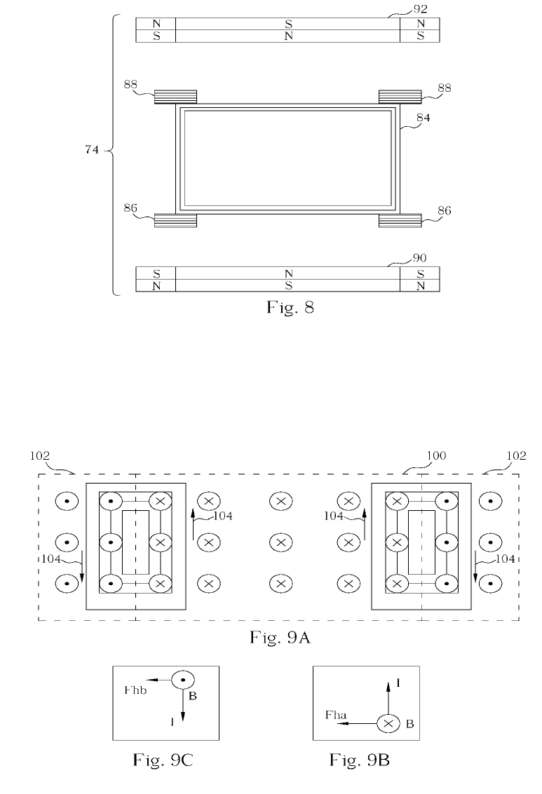

Please refer to FIG. 8, which illustrates a schematic diagram of the actuator 74 presenting a plan view of the optical pick-up head 70. The outer magnetic areas of the first permanent magnet 90 and the second permanent magnet 92 (noted as S in FIG. 7 facing the optical lens set 72) influence the outside parts of the first tracking coil set 86 and the second tracking coil set 88, but this influence does not encroach on the inner parts of the first tracking coil set 86 and the second tracking coil set 88. The coverage areas of the first permanent magnet 90 and the second permanent magnet 92 are capable of covering a shifting range of tracking coils corresponding to the different magnetic areas. The focusing coil 84 provides an upward or downward force Fp for accurately focusing the optical lens set 72 on an optical disc according to the electromagnetic induction formula in FIG. 3.

Please refer to FIG. 8, which illustrates a schematic diagram of the actuator 74 presenting a plan view of the optical pick-up head 70. The outer magnetic areas of the first permanent magnet 90 and the second permanent magnet 92 (noted as S in FIG. 7 facing the optical lens set 72) influence the outside parts of the first tracking coil set 86 and the second tracking coil set 88, but this influence does not encroach on the inner parts of the first tracking coil set 86 and the second tracking coil set 88. The coverage areas of the first permanent magnet 90 and the second permanent magnet 92 are capable of covering a shifting range of tracking coils corresponding to the different magnetic areas. The focusing coil 84 provides an upward or downward force Fp for accurately focusing the optical lens set 72 on an optical disc according to the electromagnetic induction formula in FIG. 3.

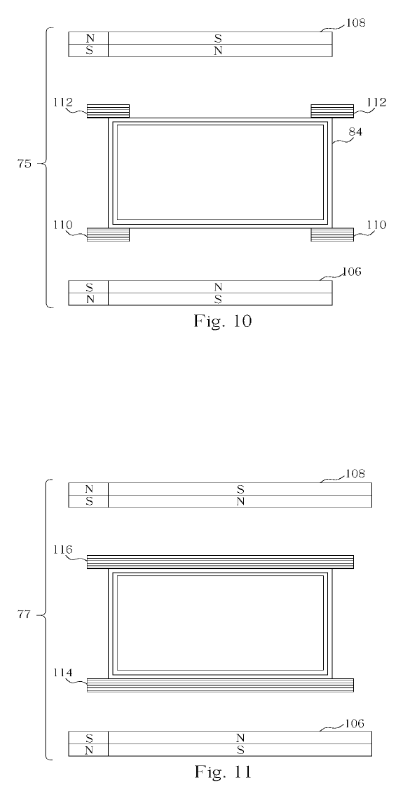

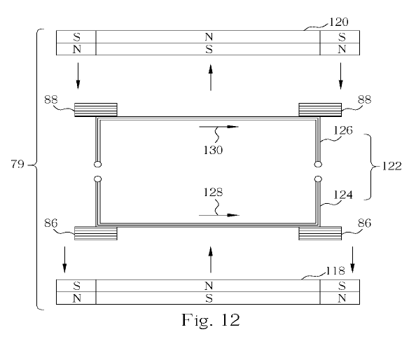

As regards the tracking process of the first tracking coil set 86 and the second tracking coil set 88 of the actuator 74, please refer to FIG. 9A, which illustrates a schematic diagram of the optical pick-up head 70 in FIG. 7 as viewed from the first permanent magnet 90 to the optical lens set 72 of FIG. 7, with only the first tracking coil set 86 shown in full. An area 100 is the magnetic field coverage area of the center portion of the first permanent magnet 90, while areas 102 are outer magnetic areas of the first permanent magnet 90. The “ ” symbols indicate the direction of magnetic lines of force as toward the optical lens set 12, while the “⊙” symbols indicate the direction of magnetic lines of force as toward the first permanent magnet 90. If the first tracking coil set 86 is driven by a current flowing as arrow 104 shows in FIG. 9A, a leftward force Fha is provided by electromagnetic induction between the first permanent magnet 90 and the first tracking coil set 86 in the area 100 as shown in FIG. 9B. Similarly, the inner part of the second tracking coil set 88 generates a force Fha, having equivalent magnitude and acting in the same sense as that generated by the first tracking coil 86. In addition, the portion of the first tracking coil set 86 falling within area 102 generates a leftward force Fhb as shown in FIG. 9C, as does the second tracking coil set 88. As a result, the tracking force provided by the first tracking coil set 86 and the first permanent magnet 90 can be expressed by Fre=Fha+Fhb, as can the tracking force provided by the second tracking coil set 88 and the second permanent magnet 92. Obviously, there is no opposing force to counter the tracking force (in this case, an opposing force would act in a rightward direction). Therefore, the present invention reverses the prior art tendency to induce a force in opposition to the tracking force, instead creating complementary forces directed in the same sense.

Additionally, because the present invention creates complementary forces directed in the same sense as the tracking force, the first tracking coil set 86 and the second tracking coil set 88 can be configured with fewer turns than the tracking coils of the prior art. Accordingly, the distances between the optical lens set 72 and the first permanent magnet 90, and between the optical lens set 72 and the second permanent magnet 92, can be decreased, so that the permanent magnetic fields influencing the first tracking coil set 86, the second tracking coil set 88, and the focusing coil 84 are effectively increased. As a result, the present invention not only eliminates the opposing forces, but also enhances the power efficiency whil tuning the position of the optical lens set 72.

Please refer to FIG. 10, which illustrates a schematic diagram of a present invention actuator 75. The actuator 75 includes a first permanent magnet 106 and a second magnet 108, both having a minor portion of magnetic area with a different polar arrangement from a major portion of magnetic area; that is, both the first permanent magnet 106 and the second permanent magnet 108 include two magnetic areas in S-N polar arrangement facing the optical lens set 72. Moreover, the actuator 75 includes a first tracking coil set 110 and a second tracking coil set 112, each having two coils mounted on one side of the optical lens set 72 parallel to the tracking line. Because both the first permanent magnet 106 and the second permanent magnet 108 include two magnetic areas in S-N arrangement facing to the optical lens set 72, the left sides (in FIG. 10) of the first tracking coil set 110 and the second tracking coil set 112 can eliminate opposing forces and create complementary forces, while the right hand sides (in FIG. 10) of the first tracking coil set 110 and the second tracking coil set 112 still include opposing forces. But still this kind of polar arrangement can improve the sensitivity and power efficiency by eliminating some of the generation of the opposing forces.

In addition, FIG. 11 illustrates a schematic diagram of an actuator 77. The actuator 77 includes a first tracking coil set 114 and a second tracking coil set 116 each having one coil for eliminating the opposing magnetic forces that would occur in the arrangement shown in FIG. 10 were the actuator 75 to be driven rightward along the tracking line 98. In the case of the arrangement shown in FIG. 11, the first tracking coil set 114 and the second tracking coil set 116 is broadened properly for balancing weight.

Please refer to FIG. 12, which illustrates a schematic diagram of an actuator 79. The most significant difference between the actuator 74 in FIG. 7 and the actuator 79 is the configuration of the first permanent magnet and the second permanent magnet, where the actuator 79 includes a first permanent magnet 118 and a second permanent magnet 120 having three magnetic areas in S-N-S polar arrangement and in N-S-N polar arrangement facing to the optical lens set 72; that is, the first permanent magnet 118 and the second permanent magnet 120 are in an attracting arrangement. Moreover, the actuator 79 includes a focusing coil 122 having a first focusing coil 124 and a second focusing coil 126 set in the optical lens set 72 parallel to the tracking line 98 (as shown in FIG. 7). The current direction for driving the first focusing coil 124 is different from that for the second focusing coil 126 (as arrows 128 and 130 shown in FIG. 12) to ensure that forces applied to the respective ends of the actuator are in the same sense relative to the first permanent magnet 118 and the second permanent magnet 120, so as to adjust the optical lens set 72 up and down stably. Similarly, the current direction for driving the first tracking coil set 86 is different from that for the second tracking coil set 88.

The above-mentioned embodiment, where the magnetic field directions of the first permanent magnet and the second permanent magnet are the same (i.e. in an attracting configuration), can be extended to other embodiments for various arrangements as shown in FIGS. 6 & 12 by utilizing proper driving currents. In addition, the magnetic poles of the first permanent magnet and the second permanent magnet can be inverted in the above-mentioned embodiments, following the rule given by FIG. 3.

In summary, the present invention optical pick-up head seeks to eliminate opposing tracking forces and create instead forces acting in the same sense by utilizing different polar arrangements of permanent magnets in the actuator from those seen in the prior art. The resulting invention can be utilized in CD, DVD, BD, AOD, HD-DVD, or other optical storage devices including ROM, R & RW applications etc. The permanent magnets of the present invention can be achieved by magnetization or other means for combining different magnetic areas. The present invention can decrease driving current or the number of windings required in the tracking coil sets, the decreased coil bulk can in turn decrease the distance between the permanent magnets and the focusing coil, such that both the required driving current and the number of windings in the focusing coil can be reduced. Therefore, with the permanent magnets of the present invention, the present invention can move the optical pick-up with high efficiency and low system resources.

Those skilled in the art will readily observe that numerous modifications and alterations of the device may be made while retaining the teachings of the invention. Accordingly, the above disclosure should be construed as limited only by the metes and bounds of the appended claims.

1. An optical pick-up head, comprising:
an optical lens set for focusing a laser beam onto an optical disc;
an actuator for fine-tuning the optical lens set comprising:
a first tracking coil set mounted on a first side of the optical lens set;
a second tracking coil set mounted on a second side of the optical lens set;
a first permanent magnet comprising at least two magnetic areas each comprising a different magnetic pole from the adjacent magnetic areas facing the first side of the optical lens and disposed at a distance; and
a second permanent magnet comprising at least two magnetic areas each comprising a different magnetic pole from the adjacent magnetic areas facing the second side of the optical lens and disposed at a distance.

2. The optical pick-up head of claim 1, further comprising a focusing coil mounted on the optical lens set, wherein a magnetic area of the first permanent magnet faces the optical lens set with the same magnetic pole as a corresponding magnetic area of the second permanent magnet faces the optical lens set.

3. The optical pick-up head of claim 1, further comprising a first focusing coil mounted on a first side of the optical lens set, a second focusing coil mounted on a second side of the optical lens set.

4. The optical pick-up head of claim 3, wherein a magnetic area of the first permanent magnet faces the optical lens set with the same magnetic pole as a corresponding magnetic area of the second permanent magnet faces the optical lens set.

5. The optical pick-up head of claim 3, wherein a magnetic area of the first permanent magnet faces the optical lens set with a different magnetic pole as a corresponding magnetic area of the second permanent magnet faces the optical lens set.

6. The optical pick-up head of claim 1, wherein the first tracking coil set comprises a tracking coil and the first permanent magnet comprises two magnetic areas, a first magnetic area with magnetic field coverage corresponding to an outer part of the tracking coil and a second magnetic area with magnetic field coverage corresponding to the other part of the tracking coil.

7. The optical pick-up head of claim 6, wherein the second tracking coil set comprises a tracking coil and the second permanent magnet comprises two magnetic areas, a third magnetic area with magnetic field coverage corresponding to an outer part of the tracking coil and a third magnetic area with magnetic field coverage corresponding to the other part of the tracking coil.

8. The optical pick-up head of claim 1, wherein the first tracking coil set comprises two tracking coils and the first permanent magnet comprises two magnetic areas, a first magnetic area with magnetic field coverage corresponding to an outer part of a first tracking coil and a second magnetic area with magnetic field coverage corresponding to an inner part of the first tracking coil and an inner part of a second tracking coil.

9. The optical pick-up head of claim 8, wherein the second tracking coil set comprises two tracking coils and the second permanent magnet comprises two magnetic areas, a third magnetic area with magnetic field coverage corresponding to an outer part of a third tracking coil and a fourth magnetic area with magnetic field coverage corresponding to an inner part of the third tracking coil and an inner part of a fourth tracking coil.

10. The optical pick-up head of claim 1, wherein the first tracking coil set comprises two tracking coils, and the first permanent magnet comprises three magnetic areas, a first magnetic area with magnetic field coverage corresponding to an outer part of a first tracking coil, and a second magnetic area with magnetic field coverage corresponding to an inner part of the first tracking coil an inner part of a second tracking coil, and third magnetic areas with magnetic fields covering an outer part of the second tracking coil.

11. The optical pick-up head of claim 10, wherein the second tracking coil set comprises two tracking coils and the second permanent magnet comprises three magnetic areas, a fourth magnetic area with magnetic field coverage corresponding to an outer part of a third tracking coil, and a fifth magnetic area with magnetic field coverage corresponding to an inner part of the third tracking coil an inner part of a fourth tracking coil, and sixth magnetic areas with magnetic fields covering an outer part of the fourth tracking coil.

12. The optical pick-up head of claim 1, further comprising a laser diode for emitting a laser beam onto the optical disc through the optical lens set.

13. The optical pick-up head of claim 1, further comprising a photo detector for receiving a reflected laser beam from the optical disc through the optical lens set.

14. An actuator of an optical pick-up head, the optical pick-up head comprising an optical lens set, the actuator comprising:
a coil set mounted on one side of the optical lens set; and
a permanent magnet facing one side of the coil set at a distance, comprising at least two magnetic areas each comprising a different magnetic polar arrangement from the adjacent magnetic areas.

15. The actuator of claim 14, wherein the coil set comprises a coil and the permanent magnet comprises two magnetic areas, a first magnetic area with magnetic field coverage corresponding to an outer part of the coil, and second magnetic area with magnetic field coverage corresponding to the other part of the coil.

16. The actuator of claim 14, wherein the coil set comprises two coils and the permanent magnet comprises three magnetic areas, a first magnetic area with magnetic field coverage corresponding to an outer part of a first coil, second magnetic area with magnetic field coverage corresponding to an inner part of the first coil and an inner part of a second coil, and third magnetic areas with magnetic fields covering an outer part of the second coil.

17. The actuator of claim 14, wherein the coil set is a tracking coil set for fine-tuning the optical lens set.

18. The actuator of claim 14, wherein the optical pick-up head further comprises a laser diode for emitting a laser beam onto the optical disc through the optical lens set.

19. The actuator of claim 14, wherein the optical pick-up head further comprises a photo detector for receiving a reflected laser beam from the optical disc through the optical lens set.
